(19) United States
(12) Patent Application Publication
(10) Pub. No.: US 2009/0221348 A1
(43) Pub. Date: Sep. 3, 2009

(54) Slot Machine Providing Return Which Increases Player's Expectation And Playing Method Thereof

(75) Inventor: Kazumasa YOSHIZAWA, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE CORP., Tokyo (JP)

(21) Appl. No.: 12/140,029

(22) Filed: Jun. 16, 2008

Related U.S. Application Data
(60) Provisional application No. 61/033,086, filed on Mar. 3, 2008.

(51) Int. Cl. A63F 9/24; A63F 13/00

(52) U.S. Cl. 463/20

(57) ABSTRACT

A countdown is performed, on condition that all kinds of animal symbols are rearranged without a payout. Then, a return is provided in the form of awarding a bonus payout, when the count-value reaches “0”.

### CROSS REFERENCE TO RELATED APPLICATION

This application claims the benefit of U.S. Provisional Application No. 61/033,086, filed on Mar. 3, 2008.

### BACKGROUND OF THE INVENTION

1. Field of the Invention

The present invention relates to a slot machine providing a return which increases player's expectation and playing method thereof.

2. Description of Related Art

Conventionally, in facilities having slot machines or the like placed therein, a variety of game media such as coins or cash are inserted into a slot machine to play a game. Each slot machine is configured to award a payout according to a winning state resulting from a game played (result of a game) Among such slot machines, there is a slot machine which provides a return to a player thereof when the loss amount of game media reaches a predetermined amount, as is disclosed in U.S. Pat. No. 5,910,048, for example.

In that slot machine, a return is provided based on the loss amount of game media or the cumulative number of games played without a payout. Therefore, before receiving a return, a player has to lose a predetermined amount of game media, or has to play a predetermined number of games without a payout. Accordingly, the player has a higher expectation for a high payout than for a return.

An object of the present invention is to provide a slot machine having an entertainment characteristic unobtainable from a conventional art, and a playing method thereof.

Another object of the present invention is to provide a slot machine which increases player's expectation for a return, and a playing method thereof.

### SUMMARY OF THE INVENTION

A slot machine of the present invention including: a display having arrangement areas arrayed in a matrix in which scatter symbols are arranged; a count device which increments/decrements a count-value; and a controller. The controller is programmed to operate in the following steps of: (a1) rearranging scatter symbols in the arrangement areas; (a2) giving a payout according to the number of each kind of the scatter symbols rearranged; (a3) when a predetermined condition is satisfied as a result of a rearrangement of scatter symbols, causing the count device to increment/decrement the count-value; and (a4) giving a bonus payout when the count-value reaches a predetermined value.

In the above structure, the count-value is incremented/decremented when a predetermined condition is satisfied as a result of a rearrangement of scatter symbols. When the count-value reaches a predetermined value, a return is provided in the form of awarding a bonus payout. Thus, the predetermined condition is satisfied at a random timing, and the count-value is incremented/decremented every time the predetermined condition is satisfied. This results in an irregular timing of providing a return. A player therefore stands a chance of receiving a return at an early stage, and this raises a higher expectation of a player for a return.

A slot machine of the present invention including: a display having arrangement areas arrayed in a matrix in which scatter symbols are arranged; a count device which increments/decrements a count-value; an input device which receives a bet operation from outside; and a controller. The controller is programmed to operate in the following steps of: (b1) rearranging scatter symbols in the arrangement areas; (b2) giving a payout according to the number of each kind of the scatter symbols rearranged; (b3) when the input device receives a predetermined bet operation from outside and a predetermined condition is satisfied as a result of a rearrangement of scatter symbols, causing the count device to increment/decrement the count-value; and (b4) giving a bonus payout when the count-value reaches a predetermined value.

In the above structure, the count-value is incremented/decremented when the input device receives a predetermined bet operation from outside and a predetermined condition is satisfied as a result of a rearrangement of scatter symbols. Then, the count-value reaches a predetermined value, a return is provided in the form of awarding a bonus payout. Thus, the predetermined condition is satisfied at a random timing, and the count-value is incremented/decremented in cases where a predetermined bet operation is received from outside when the predetermined condition is satisfied. This results in an irregular timing of providing a return. A player therefore stands a chance of receiving a return at an early stage, and this raises a higher expectation of a player for a return.

A slot machine of the present invention including: a display having arrangement areas arrayed in a matrix in which plural kinds of scatter symbols are arranged; a count device which increments/decrements a count-value; and a controller. The controller is programmed to operate in the following steps of: (c1) rearranging scatter symbols in the arrangement areas; (c2) giving a payout according to the number of each kind of the scatter symbols rearranged; (c3) when a predetermined number of kinds of scatter symbols are rearranged without a payout as a result of a rearrangement of scatter symbols, causing the count device to increment/decrement the count-value; and (c4) giving a bonus payout when the count-value reaches a predetermined value.

In the above structure, the count-value is incremented/decremented, when a predetermined number of kinds of scatter symbols are rearranged without a payout as a result of a rearrangement of scatter symbols. When the count-value reaches a predetermined value, a return is provided in the form of awarding a bonus payout. Thus, there randomly occurs a situation in which a predetermined number of kinds of scatter symbols are rearranged without a payout, and the count-value is incremented/decremented every time this situation occurs. This results in an irregular timing of providing a return. A player therefore stands a chance of receiving a return at an early stage, and this raises a higher expectation of a player for a return.

A slot machine of the present invention including: a display having arrangement areas arrayed in a matrix in which plural kinds of scatter symbols are arranged; a count device which increments/decrements a count-value; an input device which receives a bet operation from outside; and a controller. The controller is programmed to operate in the following steps of: (d1) rearranging scatter symbols in the arrangement areas; (d2) giving a payout according to the number of each kind of the scatter symbols rearranged; (d3) when the input device receives a predetermined bet operation from outside and a predetermined number of kinds of scatter symbols are rearranged without a payout as a result of a rearrangement of scatter symbols, causing the count device to increment/decrement the count-value; and (d4) giving a bonus payout when the count-value reaches a predetermined value.

In the above structure, the count-value is incremented/decremented when the input device receives a predetermined bet operation from outside, and when a predetermined number of kinds of scatter symbols are rearranged without a payout as a result of a rearrangement of scatter symbols. When the count-value reaches a predetermined value, a return is provided in the form of awarding a bonus payout. Thus, there randomly occurs a situation in which a predetermined number of kinds of scatter symbols are rearranged without a payout, and the count-value is incremented/decremented every time the situation occurs. This results in an irregular timing of providing a return. A player therefore stands a chance of receiving a return at an early stage, and this raises a higher expectation of a player for a return.

A slot machine of the present invention including: a display having arrangement areas arrayed in a matrix in which plural kinds of scatter symbols are arranged; a count device which increments/decrements a count-value; an input device which receives a bet operation from outside; and a controller. The controller is programmed to operate in the following steps of: (e1) rearranging scatter symbols in the arrangement areas; (e2) giving a payout according to the number of each kind of the scatter symbols rearranged; (e3-i) when the input device receives a predetermined bet operation from outside and a predetermined number of kinds of scatter symbols are rearranged without a payout as a result of a rearrangement of scatter symbols, causing the count device to increment/decrement the count-value, while (e3-ii) when the input device receives a predetermined bet operation from outside and a predetermined payout is given as a result of a rearrangement of scatter symbols, resetting the count-value; and (e4) giving a bonus payout when the count-value reaches a predetermined value.

In the above structure, the count-value is incremented/decremented when the input device receives a predetermined bet operation from outside, and when a predetermined number of kinds of scatter symbols are rearranged without a payout as a result of a rearrangement of scatter symbols. When the count-value reaches a predetermined value, a return is provided in the form of awarding a bonus payout. Thus, there randomly occurs a situation in which a predetermined number of kinds of scatter symbols are rearranged without a payout, and the count-value is incremented/decremented every time the situation occurs. This results in an irregular timing of providing a return. A player therefore stands a chance of receiving a return at an early stage, and this raises a higher expectation of a player for a return. In addition, the count-value is reset when the input device receives a predetermined bet operation from outside, and when a predetermined payout is given as a result of the rearrangement of scatter symbols. Thus, a return is not provided while the player's expectation for a return is lowered after a predetermined payout is awarded. On the other hand, a return is provided while the player s expectation for a return is high because a payout is scarcely given. That way player's expectation for a return is further increased.

The present invention is a playing method of a slot machine in which scatter symbols are arranged in arrangement areas of a display, the arrangement areas being arrayed in a matrix. The playing method of the slot machine including the steps of: (f1) rearranging scatter symbols in the arrangement areas; (f2) giving a payout according to the number of each kind of the scatter symbols rearranged; (f3) when a predetermined condition is satisfied as a result of a rearrangement of scatter symbols, causing the count device to increment/decrement the count-value; and (f4) giving a bonus payout when the count-value reaches a predetermined value.

In the above structure, the count-value is incremented/decremented when a predetermined condition is satisfied as a result of a rearrangement of scatter symbols. When the count-value reaches a predetermined value, a return is provided in the form of awarding a bonus payout. Thus, a predetermined condition is satisfied at a random timing, and the count-value is incremented/decremented every time the predetermined condition is satisfied. This results in an irregular timing of providing a return. A player therefore stands a chance of receiving a return at an early stage, and this raises a higher expectation of a player for a return.

According to the above-described structures, provided is a slot machine having an entertainment characteristic unobtainable from a conventional art, and a playing method thereof.

### BRIEF DESCRIPTION OF THE DRAWINGS

FIG. 1 is an explanatory view showing a playing method of a slot machine.

FIG. 2 is a block diagram of the slot machine.

FIG. 3 is an explanatory view of a display screen.

FIG. 4 is a table showing symbols and code numbers of the symbols.

FIG. 5 is an explanatory view showing a relation between the slot machine and a host computer.

FIG. 6 is a perspective view showing an appearance of the slot machine.

FIG. 7 is a block diagram showing a main control board of the slot machine.

FIG. 8 is a block diagram showing a sub control board of the slot machine.

FIG. 9 is a block diagram showing the electrical structure of the host computer.

FIG. 10 is a flow chart of a game execution process.

FIG. 11 is a flow chart of a jackpot management process.

### DESCRIPTION OF THE PREFERRED EMBODIMENTS

The following describes an embodiment of a slot machine and playing method thereof according to the present invention.

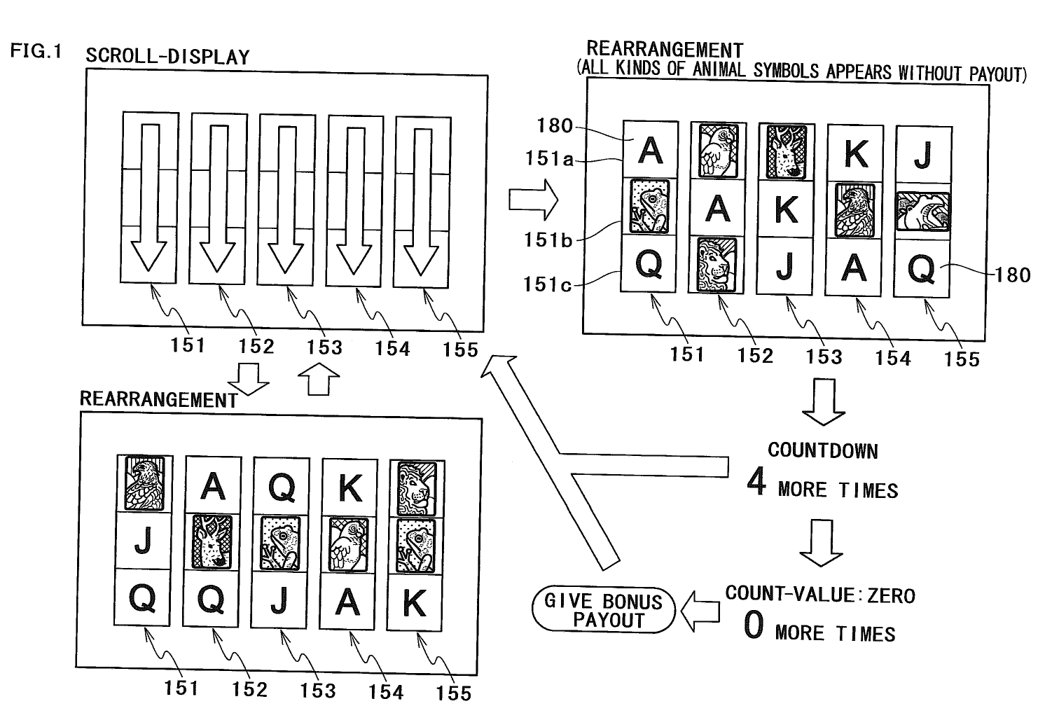

As shown in FIG. 1, the slot machine executes a playing method including the steps of: rearranging scatter symbols in arrangement areas 151 to 155 arrayed in a matrix; giving a payout according to the number of each kind of the scatter symbols rearranged; (i) when an input device receives a predetermined bet operation from outside and a predetermined number of kinds of scatter symbols are rearranged without a payout as a result of a rearrangement of scatter symbols, causing a count device to increment/decrement a count-value, while (ii) when the input device receives a predetermined bet operation from outside and a predetermined payout is given as a result of a rearrangement of scatter symbols, resetting the count-value; and giving a bonus payout when the count-value reaches a predetermined value.

In this embodiment, “predetermined bet operation” means a bet operation of Rescue bet. When a Rescue bet is made apart from a regular bet which is made in a unit game, the count-value is incremented/decremented. A regular bet is made through a regular bet operation. In this embodiment, “predetermined number of kinds of scatter symbols” mean six kinds of animal symbols. That is, scatter symbols include four kinds of alphabet symbols of “A”, “K, “Q”, and “J”, and six kinds of animal symbols. When all kinds of animal symbols are rearranged, the count-value is incremented/decremented.

In this embodiment, “bonus payout” means Rescue Payout. Rescue Payout is a payout which is awarded when the count-value reaches a predetermined value (e.g., “0”). In this embodiment, “predetermined payout” means a jackpot payout. A jackpot payout is given when a bonus trigger is established. After a jackpot payout is given, the count-value is reset.

### [Display 101]

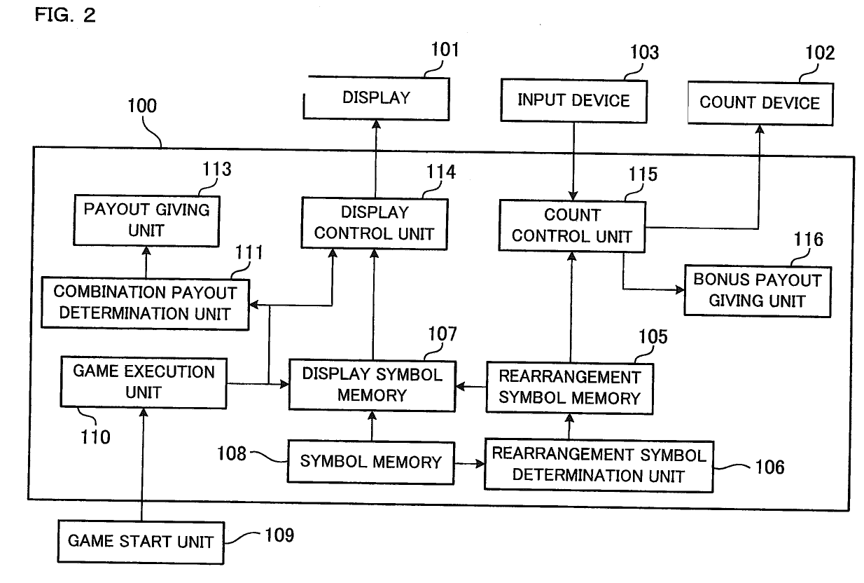

As shown in FIG. 2, the slot machine executing the above-described playing method has a display 101, a count device 102, an input device 103, and a controller 100. The display 101 has arrangement areas 151 to 155 arrayed in a matrix. In the arrangement areas 151 to 155, several kinds of scatter symbols 180 are arranged.

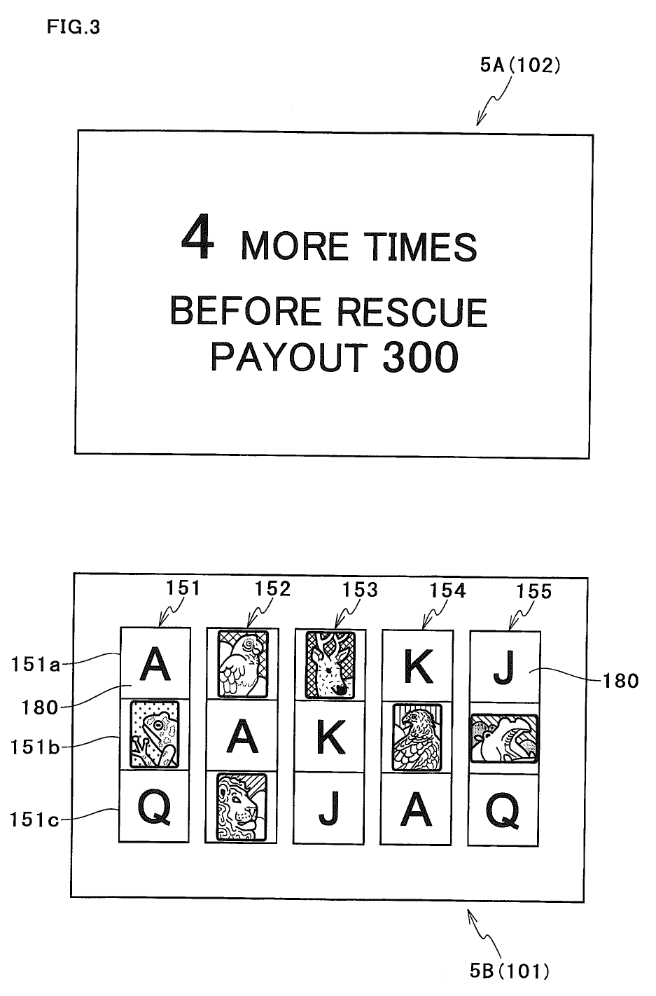

Here, “arranged” means a state where scatter symbols 180 are visually identifiable by a player. In other words, it represents a state where scatter symbols 180 are displayed in the arrangement areas 151 to 155, as shown in FIG. 3. Meanwhile, “to rearrange” means to arrange scatter symbols 180 again after releasing them.

The display 101 may be mechanically structured with a reel device which arranges scatter symbols utilizing the rotation of a reel. Alternatively, the display 101 may have an electrical structure in which scatter symbols are arranged in a video reel displayed as an image. Further, the display 101 may have a structure of a combination of the mechanical structure (reels) and the electrical structure (video reels). The electrical structure may include a liquid crystal display device, a CRT (cathode-ray tube) device, a plasma display device, or the like. The specific structure of the display 101 will be detailed later.

### [Count Device 102]

The count device 102 performs counting to increment/decrement the count-value. The counting may be performed in such a manner that the count-value increases or decreases.

The count device 102 may be mechanically structured with a counter which increments/decrements the count-value, or may have an electrical structure in which the count-value is displayed as an image. The electrical structure may include a liquid crystal display device, a CRT (cathode-ray tube) device, a plasma display device, or the like. The specific structure of the count device 102 will be detailed later.

### [Input Device 103]

The input device 103 receives at least a bet operation of Rescue bet from outside. The input device 103 may be structured with a button such as later-mentioned operation buttons 11, or may be structured with a touch panel or the like.

### [Controller 100]

The controller 100 is configured to execute: a first process of rearranging scatter symbols 180 in the arrangement areas 151 to 155 arrayed in a matrix; a second process of giving a payout according to the number of each kind of the scatter symbols 180 rearranged; a third process of, (i) when the input device 103 receives a predetermined bet operation from outside and a predetermined number of kinds of scatter symbols 180 are rearranged without a payout as a result of a rearrangement of scatter symbols 180, causing the count device 102 to increment/decrement the count-value, while (ii) when the input device 103 receives a predetermined bet operation from outside and a predetermined payout is given as a result of a rearrangement of scatter symbols 180, resetting the count-value; and a forth process of giving a bonus payout when the count-value reaches a predetermined value. In other words, the controller 100 has a first processing unit, a second processing unit, a third processing unit, and a forth processing unit.

The controller 100 has a symbol memory 108 which stores all the scatter symbols 180, and a display symbol memory 107 which stores scatter symbols to be displayed among the scatter symbols 180 stored in the symbol memory 108. The display symbol memory 107 can be accessed by a display control unit 114. In response to a control by a game execution unit 110, the display control unit 114 reads out the scatter symbols in the display symbol memory 107, and displays the scatter symbols on the display 101. A specific display state will be detailed later.

The controller 100 has a rearrangement symbol determination unit 106 which determines scatter symbols to be rearranged (hereinafter, rearrangement scatter symbols) every unit game, based on the scatter symbols 180 stored in the symbol memory 108. The rearrangement scatter symbols determined by the rearrangement symbol determination unit 106 are stored in a rearrangement symbol memory 105. Then, the rearrangement scatter symbols are output to the display symbol memory 107. After that, the rearrangement scatter symbols are displayed on the display 101 through image processing performed in the display control unit 114. That is, the controller 100 executes the first process of rearranging scatter symbols 180 in the arrangement areas 151 to 155 arrayed in a matrix.

The controller 100 is connected to a game start unit 109. The game start unit 109 has a function of outputting a game start signal in response to an operation by a player. The controller 100 has: the game execution unit 110 which executes a unit game triggered by a game start signal from the game start unit 109 in which game scatter symbols 180 are rearranged; a combination payout determination unit 111 which determines a payout according to the number of each kind of scatter symbols 180 rearranged in a unit game; and a payout giving unit 113 which gives a payout identified by the combination payout determination unit 111. That is, the controller 100 executes the second process giving a payout according to the number of each kind of the scatter symbols 180 rearranged.

Further, the controller 100 has a count control unit 115. The count control unit 115 receives the rearrangement scatter symbols determined by the rearrangement symbol determination unit 106 and stored in the rearrangement symbol memory 105. The count control unit 115 also receives information relating to a bet operation of Rescue bet received by the input device 103 from outside.

Based on the rearrangement scatter symbols received from the rearrangement symbol memory 105, the count control unit 115 determines if all kinds of animal symbols are rearranged without a payout. When the count control unit 115 determines that the input device 103 receives a bet operation of Rescue bet from outside and all kinds of animal symbols are to be arranged without a payout as a result of a rearrangement of scatter symbols 180, the count control unit 115 causes the count device 102 to increment/decrement the count-value, at a timing that scatter symbols 180 are rearranged on the display 101.

Further, the count control unit 115 determines if a jackpot payout is given, based on the rearrangement scatter symbols inputted from the rearrangement symbol memory 105. When the count control unit 115 determines that the input device 103 receives a bet operation of Rescue bet from outside and a jackpot payout is to be made as a result of a rearrangement of scatter symbols 180, the count control unit 115 resets the count-value of the count device 102 at a timing that scatter symbol 180 are rearranged on the display 101.

That is, the controller 100 executes the third process of, (i) when the input device 103 receives a predetermined bet operation from outside and a predetermined number of kinds of scatter symbols 180 are rearranged without a payout as a result of a rearrangement of scatter symbols 180, causing the count device 102 to increment/decrement the count-value, while (ii) when the input device 103 receives a predetermined bet operation from outside and a predetermined payout is given as a result of a rearrangement of scatter symbols 180, resetting the count-value.

Further, the controller 100 has a bonus payout giving unit 116 which gives a Rescue Payout as a bonus payout. The count control unit 115 determines if the count-value incremented/decremented by the count device 102 is a predetermined value. When the count control unit 115 determines that the count-value is the predetermined value, the count control unit 115 causes the bonus payout giving unit 116 to give a Rescue Payout. That is, the controller 100 executes the forth process of, giving a bonus payout when the count-value reaches a predetermined value.

Each of the blocks of the controller 100 may be realized in the form of hardware or in the form of software if necessary.

### [Operation of Controller 100]

The following describes an operation of the controller 100 having the above-described structure. First, rearrangement scatter symbols are determined by the rearrangement symbol determination unit 106. The rearrangement scatter symbols determined are stored in the rearrangement symbol memory 105. Then, the rearrangement scatter symbols stored in the rearrangement symbol memory 105 are stored in the display symbol memory 107 and the count control unit 115. Then, the rearrangement scatter symbols stored in the display symbol memory 107 are prepared to be displayed by the display control unit 114 on the display 101. When the game execution unit 110 executes a unit game, scatter symbols 180 are rearranged by having the display 101 display thereon the rearrangement scatter symbols stored in the display symbol memory 107. Thus, the controller 100 executes the first process of rearranging scatter symbols 180 in the arrangement areas 151 to 155 arrayed in a matrix.

Then, the combination payout determination unit 111 and the payout giving unit 113 give a payout according to the number of each kind of the scatter symbols 180 rearranged. Thus, the controller 100 executes the second process of giving a payout according to the number of each kind of the scatter symbols 180 rearranged.

Meanwhile, the rearrangement scatter symbols stored in the count control unit 115 are used to determine if the count-value is incremented/decremented. When the count control unit 115 determines that the count-value is incremented/decremented, the count device 102 increments/decrements the count-value. Also, the rearrangement scatter symbols stored in the count control unit 115 are used to determine if a jackpot payout is given. When the count control unit 115 determines that a jackpot payout is given, the count-value of the count device 102 is reset. Thus, the controller 100 executes the third process of, (i) when the input device 103 receives a predetermined bet operation from outside and a predetermined number of kinds of scatter symbols 180 are rearranged without a payout as a result of a rearrangement of scatter symbols 180, causing the count device 102 to increment/decrement the count-value, while (ii) when the input device 103 receives a predetermined bet operation from outside and a predetermined payout is given as a result of a rearrangement of scatter symbols 180, resetting the count-value.

The rearrangement scatter symbols stored in the count control unit 115 are also used to determine if the count-value reaches a predetermined value (to determine if a Rescue Payout is given). When the count control unit 115 determines that a Rescue Payout is given, the bonus payout giving unit 116 gives a Rescue Payout as a bonus payout. Thus, the controller 100 executes the forth process of, giving a bonus payout when the count-value reaches a predetermined value.

As clearly seen from the above operations, as well as shown in FIG. 1, the slot machine 1 realizes a playing method including: rearranging scatter symbols 180 in the arrangement areas 151 to 155 of the display 101 arrayed in a matrix; giving a payout according to the number of each kind of the scatter symbols 180 rearranged; (i) when the input device 103 receives a predetermined bet operation from outside and a predetermined number of kinds of scatter symbols 180 are rearranged without a payout as a result of a rearrangement of scatter symbols 180, causing the count device 102 to increment/decrement the count-value, while (ii) when the input device 103 receives a predetermined bet operation from outside and a predetermined payout is given as a result of a rearrangement of scatter symbols 180, resetting the count-value; and giving a bonus payout when the count-value reaches a predetermined value.

According to the above-described playing method, the count-value is incremented/decremented when the input device 103 receives a predetermined bet operation from outside and a predetermined number of kinds of scatter symbols are rearranged without a payout as a result of a rearrangement of scatter symbols. When the count-value reaches a predetermined value, a return is provided in the form of awarding a bonus payout. Thus, there randomly occurs a situation in which a predetermined number of kinds of scatter symbols 180 are rearranged without a payout. When a predetermined bet operation is received from outside in this situation, the count-value is incremented/decremented. This results in an irregular timing of providing a return. A player therefore stands a chance of receiving a return at an early stage, and this raises a higher expectation of a player for a return.

When the input device 103 receives a predetermined bet operation from outside and a predetermined payout is given as a result of a rearrangement of scatter symbols 180, the count-value is reset. Thus, a return is not provided while the player's expectation for a return is lowered after a predetermined payout is awarded. On the other hand, a return is provided while the player's expectation for a return is high because a payout is scarcely given. That way player's expectation for a return is further increased.

### [Display State]

Specifically described hereinafter are exemplary display states of the display 101 and the count device 102 in the slot machine 1 and in the operation process of the playing method thereof. The following description deals with a case where scatter symbols are arranged on the display 101 of a video reel-type and where the count device 102 video-displays the count-value, as shown in FIG. 3.

The display 101 has arrangement areas 151, 152, 153, 154, and 155 in which scatter symbols 180 are arranged. In the arrangement areas 151, 152, 153, 154, and 155, symbol columns having more than one scatter symbols 180 are scroll-displayed, respectively (see FIG. 1). Each of the arrangement areas 151, 152, 153, 154, and 155 is divided into an upper row 151a, a middle row 151b, and a lower row 151c. Scatter symbols 180 are stopped (arranged) on the rows 151a, 151b, and 151c of the respective arrangement areas. For example, in FIG. 3, “A” is stopped on the upper row 151a of the arrangement area 151, “FROG” is stopped on the middle row 151b of the arrangement area 151, and “Q” is stopped on the lower row 151c of the arrangement area 151. Thus, the arrangement areas 151, 152, 153, 154, and 155 display a symbol matrix of five columns and three rows. Note that the symbol matrix is not limited to a matrix of five columns and three rows.

This embodiment deals with a case where a process of paying out a coin or the like is performed, when a predetermined number (e.g., four) or more scatter symbols of a same kind are displayed on the display 101. However, it is possible to employ such a configuration that, for example, a payline L is provided so as to cross the middle row 151b of the arrangement areas 151, 152, 153, 154, and 155, and when scatter symbols stopped on the payline L correspond to a predetermined combination, a coin is paid out.

When a Rescue bet is made, the count device 102 displays the count-value which represents the number of times of establishment remained before a Rescue Payout is awarded. The initial value of the count-value is “5”. As shown in FIG. 3, all kinds of (six kinds of) animal symbols are rearranged on the display 101, a countdown of the count-value is performed. When the count-value reaches “0”, performed is a process of paying out “300” coins, as a Rescue Payout, or the like.

### [Scatter Symbols]

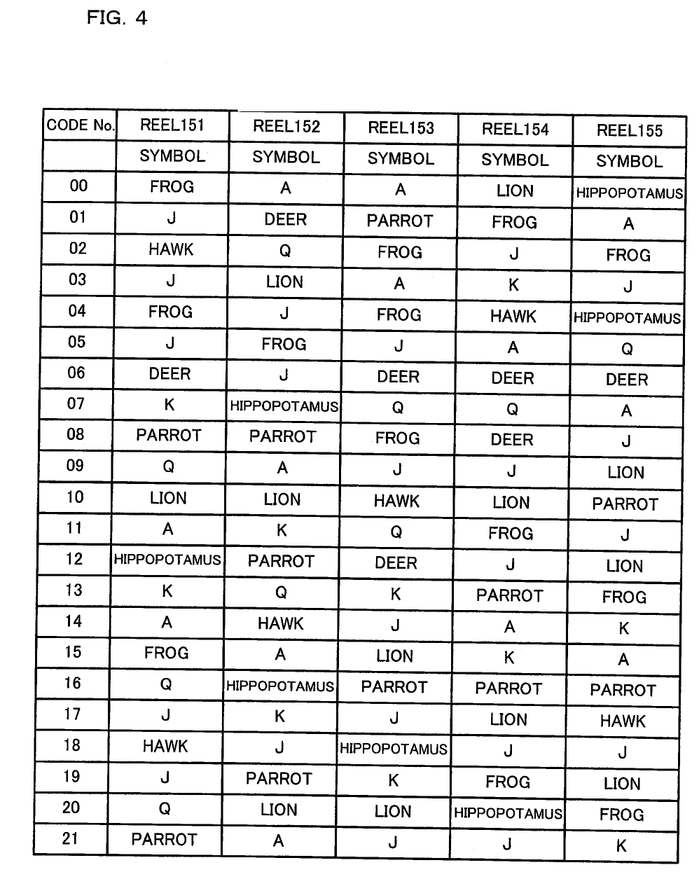

As shown in FIG. 4, scatter symbols 180 displayed in the arrangement areas 151, 152, 153, 154, and 155 of the display 101 constitute symbol columns so that each symbol column has twenty-two scatter symbols. Each symbol of each symbol column has a code number, any one of numbers between 0 to 21. Each of the symbol columns is structured with a combination of scatter symbols of “A”, “K”, “Q”, “J”, “FROG”, “HAWK”, “DEER”, “PARROT”, “LION”, and “HIPPOPOTAMUS”.

Successive three scatter symbols of each symbol column are displayed (arranged) respectively in the upper row 151a, the middle row 151b, and the lower row 151c of each of the arrangement areas 151, 152, 153, 154, and 155, thereby constituting a symbol matrix of five columns and three rows. When a later-mentioned BET button and a start button are sequentially pressed in this order to start a game, scatter symbols constituting a symbol matrix start to scroll. After the symbols are scrolled for a predetermined period of time, the scrolling of symbols stops (symbols are rearranged).

When a predetermined number or more scatter symbols of a same kind are displayed in the arrangement areas 151, 152, 153, 154, and 155, a player gets an advantage. To get an advantage means that coins are paid out according to scatter symbols displayed, the value of coins to be paid out is added to a credit value, a bonus game is started, or the like.

Specifically, when four or more scatter symbols of a same kind are rearranged in the arrangement areas 151, 152, 153, 154, and 155, twenty coins (game media) are paid out for one bet. Meanwhile, when four or more scatter symbols of “A” are rearranged, a bonus trigger is established. This causes a transition of gaming state from a basic game to a bonus game.

Here, a bonus game is a gaming state which provides a larger advantage than a basic game. In this embodiment, a bonus game is to make a jackpot payout. Note that another bonus game may be employed in combination, provided that the other bonus game is advantageous to a player, i.e., the other bonus game is more advantageous than a basic game. For example, that other bonus game which may be employed is a game providing: a state where a larger amount of game media can be obtained than in a basic game; a state where game media can be obtained more likely than in a basic game; or a state where a smaller amount of game media are consumed than in a basic game. A specific example of that other bonus game is a free game which allows a player to play a game for a predetermined number of times without betting a coin.

### [Mechanical Structure of the Slot Machine 1]

Next, the following describes a specific example of mechanical and electrical structures of the slot machine 1 thus structured.

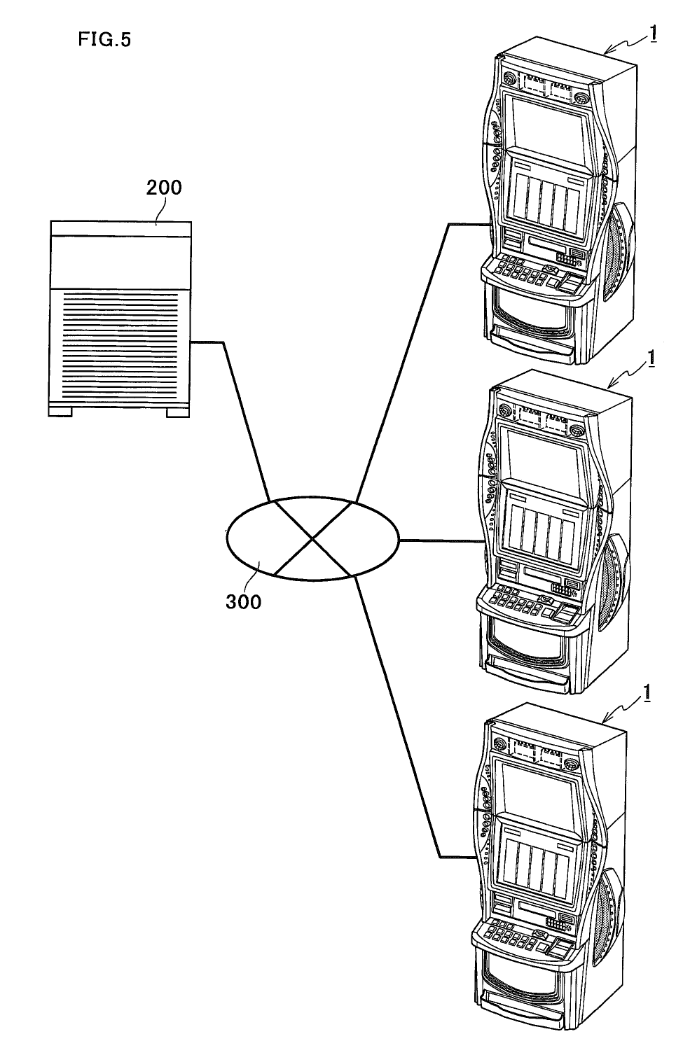

As shown in FIG. 5, slot machines 1 are placed in a game arcade such as a casino. Each slot machine 1 is communicably connected to a host computer 200 via internet communication network 300.

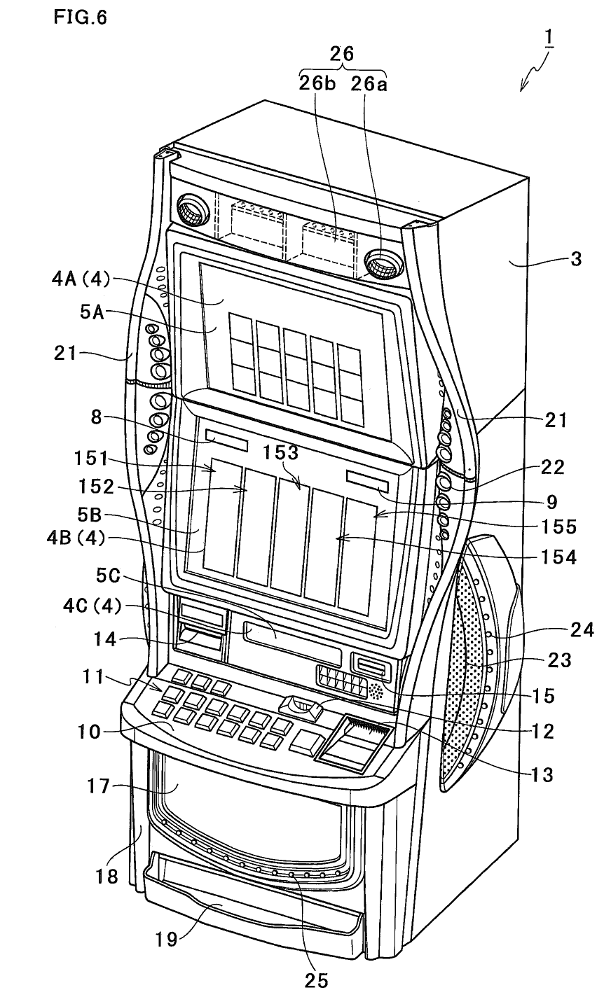

As shown in FIG. 6, the slot machine 1 is an upright slot machine and has a cabinet 3 for housing electrical or mechanical components for executing a predetermined game mode. As a display unit 4 for displaying game information in response to a player's game operation, there may be provided an upper variable display unit 4A, a middle variable display unit 4B, and a lower variable display unit 4C. The display units 4A to 4C are attached to the front face of the cabinet 3 having a longer length in the vertical direction.

The upper variable display unit 4A has a transparent upper liquid crystal panel 5A fixed to a front door of the cabinet 3. On the upper liquid crystal panel 5A, the count-value is displayed when Rescue mode is activated (ON). Here, Rescue mode is a state during which a Rescue Payout may be generated in response to a Rescue bet. This Rescue mode starts (is set to ON) upon making a Rescue bet, and ends (is set to OFF) after a Rescue Payout is awarded.

The middle variable display unit 4B is a display panel for rotating symbols, which is to be constantly viewed by a player. The middle variable display unit 4B has a transparent center liquid crystal panel 5B fixed to the front door of the cabinet 3. On the center liquid crystal panel 5B, five arrangement areas 151, 152, 153, 154, and 155 are displayed. Further, on the center liquid crystal panel 5B, an effect of moving images is performed at a time of winning or the like. Further, in an upper portion of the center liquid crystal panel 5B, a payout number indicator 8 and a credit number indicator 9 are displayed.

The lower variable display unit 4C has a lower liquid crystal panel 5C which displays the number of points stored in a card or the number of points of a game. Such a number is displayed on the lower liquid crystal panel 5C based on a result displayed on the middle variable display unit 4B. When a winning is established in the middle variable display unit 4B, the number of points of the game displayed on the lower liquid crystal panel 5C is increased according to the type of the winning established. On the left of the lower liquid crystal panel 5C, a ticket printer 14 is provided. On the right of the lower liquid crystal panel 5C, a card reader 15 is provided. Note that winning means an occasion where four or more scatter symbols of a single kind are rearranged, awarding a various payouts according to the result.

Below the lower variable display unit 4C is disposed an operation table 10 which protrudes forward from the front face of the cabinet 3. On the operation table 10, there are arranged operation buttons 11 (e.g., a BET button, a collect button, a start button, a stop button, a rescue button or the like) serving as a control panel which enables a player to perform a game-related operation. In addition, the operation table 10 is provided with a coin insertion slot 12 and a bill insertion slot 13.

Below the operation table 10, a waist-high panel 17 is disposed. The waist-high panel 17 is a plastic panel having a game-related image printed thereon. This waist-high panel 17 is fixed to a lower front door 18 and illuminated by a cold cathode tube. Further, below the waist-high panel 17 is disposed a coin receiving tray 19 for storing a coin paid out based on a game result.

Further, a light emitting unit 20 is disposed on the cabinet 3 of the slot machine 1 so as to surround game areas including the upper variable display unit 4A, the middle variable display unit 4B, the lower variable display unit 4C, and the operation table 10. The light emitting unit 20 has side lamps 22, speaker lamps 24, under lamps 25, and top lamps 26. The side lamps 22 are provided on inclined parts 21 provided at the front right and front left of the cabinet 3, each of which parts protruding in a bow shape so as to extend over the upper variable display unit 4A, the middle variable display unit 4B and the lower variable display unit 4C. The speaker lamps 24 are provided on arc-shaped speakers 23 which protrudes sideways at the right and a left ends of the cabinet 3 adjacent to the operation table 10. The speaker lamps 24 are arranged along edges of the speakers 23. The under lamps 25 are provided on the lower front door 18 and arranged along a lower edge of the waist-high panel 17. The top lamps 26 are provided above the upper variable display unit 4A. The top lamps including power lamps 26a disposed at both sides respectively and band-type lamps 26b arranged in a horizontal direction between the power lamps.

### [Electrical Structure of the Slot Machine 1]

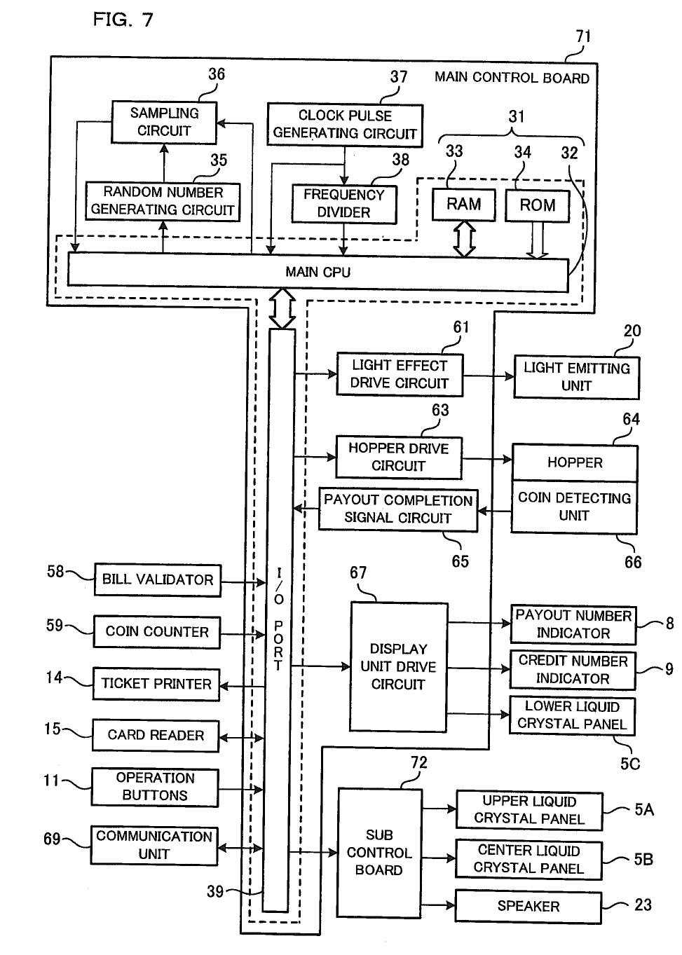

FIG. 7 is a block diagram showing an overall electrical structure of the slot machine 1. As shown in FIG. 7, the slot machine 1 has various components, among which a main control board 71 including a microcomputer 31 is a central component. The main control board 71 has the microcomputer 31, a random number generating circuit 35, a sampling circuit 36, a clock pulse generating circuit 37, and a frequency divider 38. The main control board 71 also has a light effect drive circuit 61, a hopper drive circuit 63, a payout completion signal circuit 65, and a display unit drive circuit 67.

The microcomputer 31 has a main CPU 32, a RAM 33, and a ROM 34. The main CPU 32 operates in accordance with a program stored in the ROM 34. The main CPU 32 executes an input/output of a signal to/from other components through an I/O port 39 to control the operation of the whole slot machine 1. In the RAM 33 is stored data or a program to be used when the main CPU 32 operates. For example, in the RAM 33, a random number resulting from sampling by the sampling circuit 36 (described later) is temporarily kept after a game is started, and the code numbers of the symbol columns shown in FIG. 4 are stored. The ROM 34 stores a program executed by the main CPU 32, and permanent data.

The random number generating circuit 35 operates according to an instruction of the main CPU 32, and generates a predetermined range of random numbers. According to an instruction of the main CPU 32, the sampling circuit 36 samples a random number from those generated by the random number generating circuit 35, and inputs the random number sampled to the main CPU 32. The clock pulse generating circuit 37 generates a reference clock for operating the main CPU 32. The frequency divider 38 divides the reference clock into certain cycles, and inputs the resulting signal to the main CPU 32.

The main control board 71 is connected to the operation buttons 11 including the stop button for inputting an instruction to stop scrolling of the symbol columns, the start button, the collect button, the BET button, or the like. When pressing any of these buttons, a corresponding signal is input to the main CPU 32 via the I/O port 39. Note that the operation buttons 11 include the rescue button for making a Rescue bet.

Further, the main control board 71 is connected to a bill validator 58, a coin counter 59, a ticket printer 14, a card reader 15, and a communication unit 69.

The bill validator 58 reads an image on a bill inserted to the bill insertion slot 13 and accepts a genuine bill into the cabinet 3. When accepting a genuine bill, the bill validator 58 outputs an input signal to the main CPU 32 based on the amount of the bill. The main CPU 32 stores in the RAM 33 the number of credits corresponding to the amount of the bill transmitted by the input signal.

The coin counter 59 is provided inside the coin insertion slot 12, and validates whether a coin inserted by a player into the coin insertion slot 12 is genuine. Anything other than a genuine coin is discharged to the coin receiving tray 19. The coin counter 59 outputs an input signal to the main CPU 32 when detecting a genuine coin.

Based on a control signal output from the main CPU 32, the ticket printer 14 prints a bar code on a ticket, and then outputs the ticket with a bar code. Data such as the number of credits stored in the RAM 33, time and date, identification number of a slot machine 1, or the like is encoded to the bar code.

The card reader 15 reads data from a smart card to transmit them to the main CPU 32, or write data to a smart card based on a control signal from the main CPU 32.

The communication unit 69 communicates with the host computer 200 or the like provided in a game arcade via a communication line.

The light effect drive circuit 61 outputs an effect signal to cause the above-mentioned light emitting unit 20 to perform a light effect. The light emitting unit 20 is structured with various lamps and LEDs including the above-mentioned side lamps 22, speaker lamps 24, under lamps 25, and top lamps 26.

The hopper drive circuit 63 drives a hopper 64 according to a control by the main CPU 32. The hopper 64 operates so as to pay out a coin to the coin receiving tray 19. The payout completion signal circuit 65 receives data of the number of coins from a coin detecting unit 66 connected thereto. When the number of coins reaches a predetermined number, the payout completion signal circuit 65 inputs to the main CPU 32 a signal notifying that an operation of paying out a coin has been completed. The coin detection unit 66 measures the number of coins paid out by the hopper 64, and inputs data of the measured number to the payout completion signal circuit 65. The display unit drive circuit 67 controls the display operations of various display units, such as the payout number indicator 8, the credit number indicator 9, the lower liquid crystal panel 5C or the like.

When the start button is pressed after a credit is bet, the main CPU 32 controls a sub CPU 74 of a sub control board 72 so as to (i) output a command signal to scroll scatter symbols 180 displayed on the center liquid crystal panel 5B, (ii) determine scatter symbols to be stopped after scatter symbols 180 are scrolled, and (iii) stop the determined scatter symbols in the arrangement areas 151, 152, 153, 154, and 155.

That is, the main CPU 32 functions as an arrangement controller to execute an arrangement control by which, among various kinds of scatter symbols, symbols to be arranged in a symbol matrix are selected and determined, and then scrolling of the symbols is stopped so that the determined symbol matrix appears. With this function, scatter symbols 180 displayed while being scrolled on the center liquid crystal panel 5B are rearranged in a new symbol matrix.

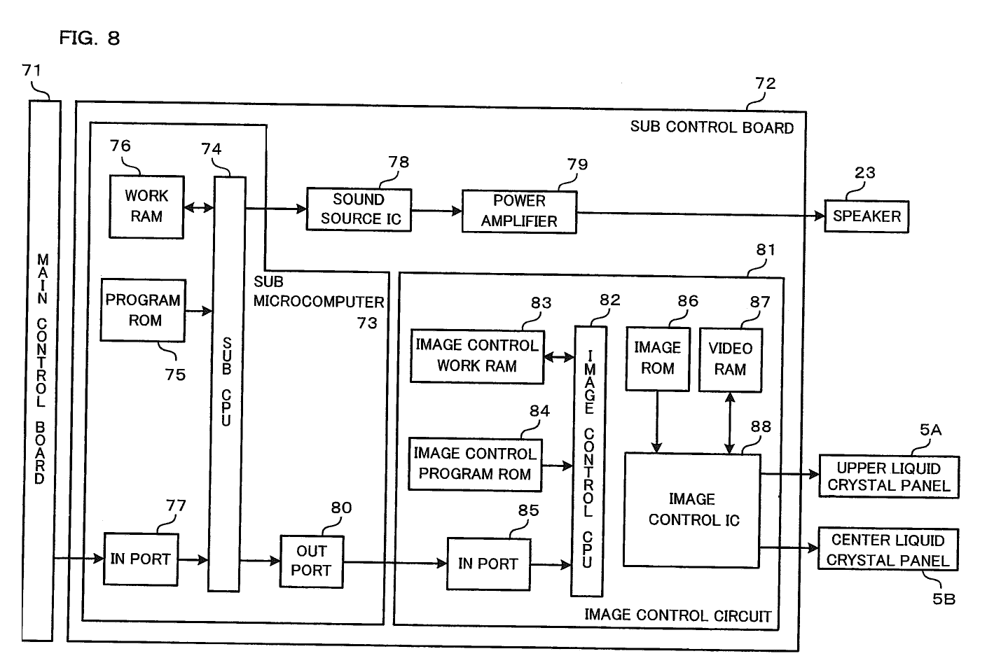

Further, the sub control board 72 is connected to the main control board 71. As shown in FIG. 8, the sub control board 72 receives a command input via the main control board 71, controlling the display on the upper liquid crystal panel 5A of the variable display unit 4A, the display on the center liquid crystal panel 5B of the variable display unit 4B, and the output of the sound from the speakers 23. The sub control board 72 is constructed on a circuit board different from the circuit board constituting the main control board 71, and has a microcomputer (hereinafter referred to as “sub microcomputer”) 73 as a main component. The sub control board 72 has a sound source IC 78 controlling the sound output from the speakers 23, a power amplifier 79 serving as an amplifier, and an image control circuit 81 acting as a display control unit of the upper liquid crystal panel 5A and the center liquid crystal panel 5B.

The sub microcomputer 73 has a sub CPU 74 which performs a control operation according to a control command transmitted from the main control board 71, a program ROM 75 serving as a memory, a work RAM 76, an IN port 77, and an OUT port 80. The sub control board 72 does not include a clock pulse generating circuit, a frequency divider, a random number generating circuit, and a sampling circuit. However, the sub control board 72 is configured to execute random number sampling on an operation program of the sub CPU 74. The program ROM 75 stores a control program executed in the sub CPU 74. The work RAM 76 acts as a temporary memory when the control program is executed in the sub CPU 74.

The image control circuit 81 has an image control CPU 82, an image control work RAM 83, an image control program ROM 84, an IN port 85, an image ROM 86, a video RAM 87, and an image control IC 88. Based on a parameter set in the sub microcomputer 73, the image control CPU 82 determines an image displayed on the upper liquid crystal panel 5A and the center liquid crystal panel 5B, according to an image control program stored in the image control program ROM 84.

The image control program ROM 84 stores the image control program relating to the display on the upper liquid crystal panel SA and the center liquid crystal panel 5B, and various selection tables. The image control work RAM 83 acts as a temporary memory when the image control program is executed in the image control CPU 82. The image control IC 88 forms an image corresponding to the content determined in the image control CPU 82, and outputs the image on the upper liquid crystal panel 5A and the center liquid crystal panel 5B.

The image ROM 86 stores dot data for forming an image. The video RAM 87 acts as a temporary memory when the image control IC 88 forms an image.

### [Electrical Structure of the Host Computer 200]

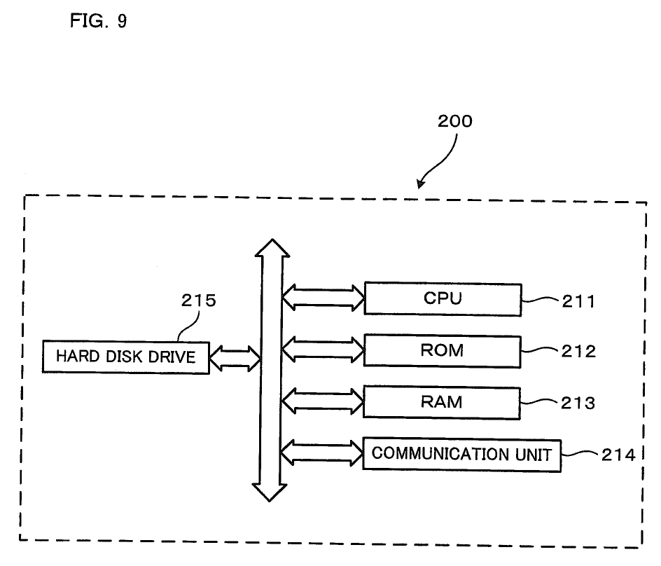

FIG. 9 is a block diagram showing the internal structure of the host computer 200. The host computer 200 includes a CPU 211 serving as a processing unit, a ROM 212, a RAM 213 serving as a temporary memory device, a communication unit 214, and a hard disk drive 215.

The CPU 211 executes a later-described jackpot management process routine, thereby accumulating jackpot credits according to a jackpot system. The jackpot credits are accumulated by adding up 0.5% of a credit value bet through a regular bet operation in every unit game in each slot machine 1. When a bonus trigger is established in any of the slot machines 1, jackpot credits accumulated so far is fully paid out in that slot machine 1.

The communication unit 214 is communicably connected to the communication unit 69 of each of the slot machines 1 via the internet communication network 300. The RAM 213 stores the number of jackpot credits. The ROM 212 stores a system program for controlling the operation of a control device, permanent data, or the like. The hard disk drive 215 stores a payout-awarding state or the like of each of the slot machines 1.

### [Process Operation of the Slot Machine 1]

Next, the following describes the process executed in the slot machine 1. The main CPU 32 reads out a game program to execute the game program, thereby running a game.

### [Game Execution Process]

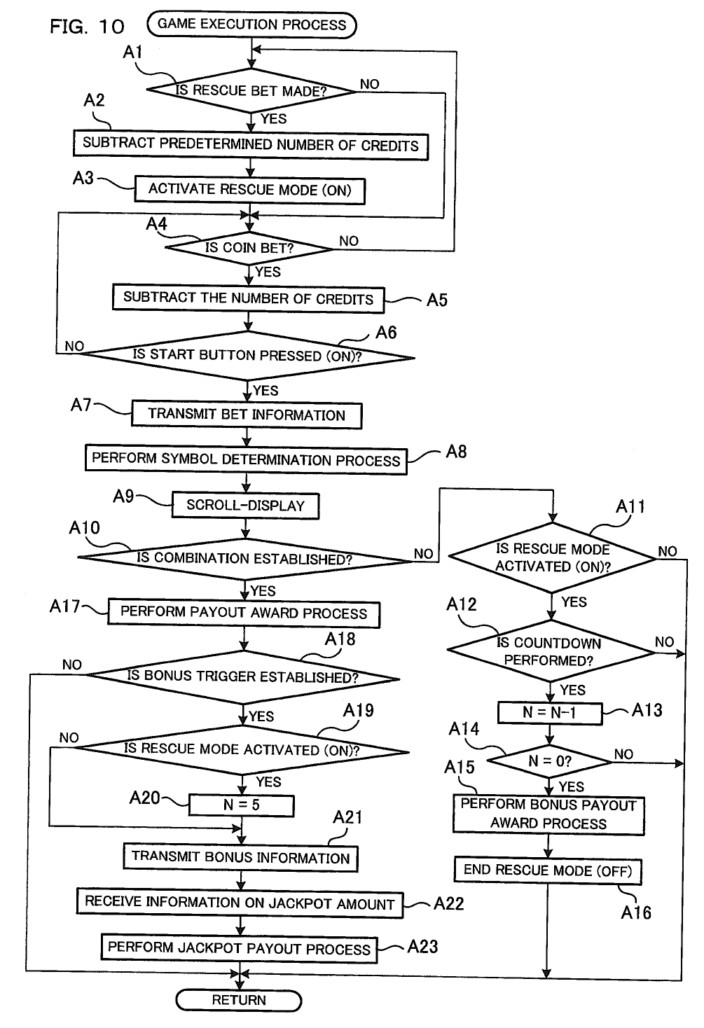

The main CPU 32 of the slot machine 1 executes a game execution process routine shown in FIG. 10. In the game execution process routine, first, the main CPU 32 determines if a Rescue bet is made (A1). Note that a Rescue bet is made by operating the rescue button included in the operation buttons 11. When it is determined that a Rescue bet is made (A1, YES), a predetermined number of (e.g., 10) credits is subtracted from the number of credits stored in the RAM 33 (A2) Then, Rescue mode is activated (set to ON) (A3).

When it is determined that a Rescue bet is not made in the step A1 (A1, NO), or after the step A3, the main CPU 32 determines if a coin is bet (A4). In this step, it is determined if an input signal given by pressing of the BET button is received. It is determined that a coin is not bet (A4, NO), the step Al is executed again to enter a standby mode until a coin is bet.

On the other hand, it is determined that a coin is bet (A4, YES), the number of credits corresponding to the number of coins bet is subtracted from the number of credits stored in the RAM 33 (A5). When the number of coins bet is larger than the number of credits stored in the RAM 33, the process of subtracting the number of credits is not performed, and the step A5 is executed again.

Next, it is determined if the start button is pressed (set to ON) (A6). If it is determined that the start button is not pressed (not set to ON) (A6, NO), the process returns to the step A4. While the start button is not pressed (not set to ON) (for example, when an instruction to finish the game is input while the start button is not pressed (not set to ON)), the result of subtraction in the step A5 is canceled.

On the other hand, when it is determined that the start button is pressed (set to ON) (A6, YES), bet information is transmitted to the host computer 200 (A7). Then, a symbol determination process is performed (A8). That is, a stop symbol determination program stored in the RAM 33 is executed to determine a symbol matrix.

Then, scatter symbols 180 in the arrangement areas 151, 152, 153, 154, and 155 are scroll-displayed (A9). After the scatter symbols 180 are scrolled, the symbol matrix determined in the step A8 is stopped (rearranged) in the arrangement areas 151, 152, 153, 154, and 155.

Then, it is determined if a combination is established, i.e., if four or more scatter symbols 180 of a same kind are rearranged (A10). When it is determined that a combination is not established (A10, NO), it is determined if Rescue mode is activated (ON) (A11). When it is determined that Rescue mode is activated (ON) (A11, YES), it is determined if to perform a countdown (A12). When all kinds of animal symbols are rearranged and it is determined to perform a countdown (A12, YES), a count-value “n” is decremented by “1” (A13). Then, it is determined if the count-value “n” is “0” (A14). When it is determined that the count-value “n” is “0” (A14, YES), there is performed a bonus payout award process of paying out a Rescue Payout whose number of credits is “300” (A15). Then, Rescue mode is ended (is set to OFF) (A16), and this routine ends.

This routine ends, (i) when it is determined that Rescue mode is not activated (not ON) in the step A11 (A11, NO), (ii) when it is determined not to start a countdown in the step A12 (A12, NO), or (iii) when it is determined that the count-value “n” is not “0” in the step A14 (A14, NO).

In the step A10, when it is determined that a combination is established (A10, YES), a payout award process is executed (A17). That is, the number of coins to be paid out is calculated according to the number of scatter symbols of a same kind. When a coin to be paid out is reserved, a predetermined number of credits is added to the number of credits stored in the RAM 33. On the other hand, when a coin is paid out, a control signal is transmitted to the hopper 64 to pay out a predetermined number of coins to the coin receiving tray 19.

Then, it is determined if a bonus trigger is established (A18). When it is determined that a bonus trigger is not established (A18, NO), this routine ends. On the other hand, when it is determined that a bonus trigger is established (A18, YES), it is determined if Rescue mode is activated (ON) (A19). When it is determined that Rescue mode is activated (ON) (A19, YES), the count-value “n” is reset to “5” (A20).

When it is determined that Rescue mode is not activated (not ON) in the step A19 (A19, NO), or after the step A20, bonus information is transmitted to the host computer 200 (A21). Then, information on jackpot amount is received from the host computer 200 (A22), a jackpot payout process is performed (A23), and then this routine ends.

As described above, when the input device 103 (operation buttons 11) receives a predetermined bet operation (bet operation of Rescue bet) from outside and a predetermined number of kinds of scatter symbols (all kinds of animal symbols) are rearranged without a payout as a result of a rearrangement of scatter symbols 180, the count-value is incremented/decremented. Then, when the count-value reaches a predetermined value (e.g., “0”), a bonus payout (Rescue Payout) is given thereby providing a return. Thus, there randomly occurs a situation in which a predetermined number of kinds of scatter symbols 180 are rearranged without a payout. When a predetermined bet operation is received from outside in this situation, the count-value is incremented/decremented. This results in an irregular timing of providing a return. A player therefore stands a chance of receiving a return at an early stage, and this raises a higher expectation of a player for a return.

When the input device 103 receives a predetermined bet operation from outside and a predetermined payout (jackpot payout) is awarded as a result of a rearrangement of scatter symbols 180, the count-value is reset. Thus, a return is not provided while the player s expectation for a return is lowered after a predetermined payout is awarded. On the other hand, a return is provided while the player s expectation for a return is high because a payout is scarcely given. That way player's expectation for a return is further increased.

### [Jackpot Management Process]

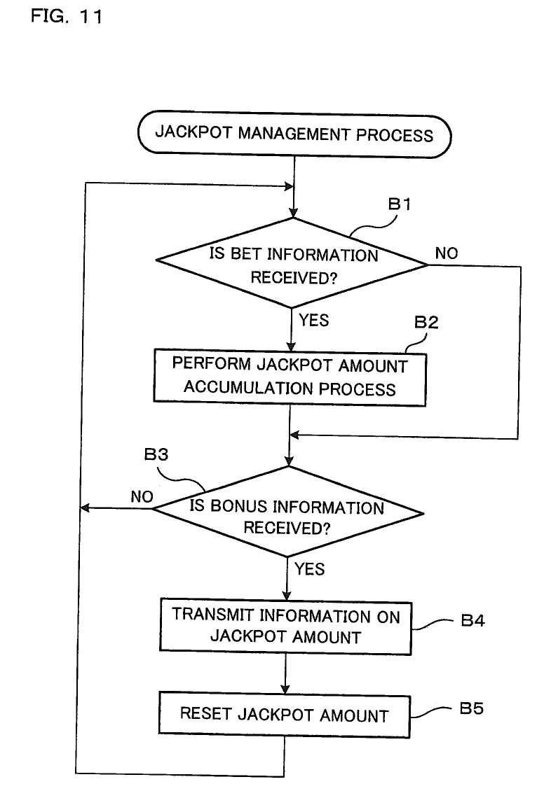

The CPU 211 of the host computer 200 executes a jackpot management process routine shown in the FIG. 11. In the jackpot management process routine, first, the CPU 211 determines if bet information is received from each of the slot machines 1 (B1). It is determined that bet information is received (B1, YES), a jackpot amount accumulation process is performed (B2) When it is determined that bet information is not received in the step B1 (B1, NO), or after the step B2, it is determined if bonus information is received from any of the slot machines 1 (B3). When it is determined that bonus information is not received (B3, NO), the process returns to the step B1. On the other hand, it is determined that bonus information is received (B3, YES), information on the jackpot amount is transmitted to an applicable slot machine out of the slot machines 1 (B4), the jackpot amount is reset to “0” (B5), and then the process returns to the step B1.

In the detailed description provided above, characteristic parts have mainly been described in order that the present invention can be understood more easily. However, the present invention is not limited to the embodiment shown in the detailed description provided above, and may be applied to other embodiments. The scope of application of the present invention should be construed as broadly as possible. Terms and phraseologies adopted in the present specification are for correctly illustrating the present invention, not for limiting. It would be easy for those skilled in the art to derive, from the spirit of the invention described in the present specification, other structures, systems, methods and the like which are included in the spirit of the invention. Accordingly, it should be considered that claims cover equivalent structures, too, without departing from the technical idea of the present invention. An object of the abstract is to enable an intellectual property office, general public institutions, persons belonging to the art but not familiar with patent, legal terms, or technical terms to quickly understand technical contents and essences of the present invention through a simple research. Therefore, the abstract is not intended to limit the scope of the invention that should be evaluated by the claims. In addition, it is desirable to sufficiently refer to already-disclosed documents and the like, in order to fully understand the objects and effects of the present invention.

The detailed description provided above includes a processing which is executed on a computer or a computer network. The descriptions and expressions provided above are given for the purpose of allowing those skilled in the art to understand the invention most effectively. In the specification, respective steps used to induce one result, or blocks having a predetermined processing function should be understood as a processing having no self-contradiction. In addition, in each step or block, an electrical or magnetic signal is transmitted/received, recorded, and the like. In a processing in each step or block, such a signal is embodied in the form of a bit, a value, a symbol, a character, a term, a number, and the like. However, it should be noted that they have been used simply because they are convenient for explanations. A processing in each step or block has sometimes been described using an expression which is common to a human behavior. However, in principle, the processing described in the specification is executed by various devices. In addition, other structures necessary for each step or block are apparent from the above description.

What is claimed is:

1. A slot machine comprising:
a display having arrangement areas arrayed in a matrix in which scatter symbols are arranged;
a count device which increments/decrements a count-value; and
a controller which is programmed to operate in the following steps of:
(a1) rearranging scatter symbols in the arrangement areas;
(a2) giving a payout according to the number of each kind of the scatter symbols rearranged;
(a3) when a predetermined condition is satisfied as a result of a rearrangement of scatter symbols, causing the count device to increment/decrement the count-value; and
(a4) giving a bonus payout when the count-value reaches a predetermined value.

2. A slot machine comprising:
a display having arrangement areas arrayed in a matrix in which scatter symbols are arranged;
a count device which increments/decrements a count-value;
an input device which receives a bet operation from outside; and
a controller which is programmed to operate in the following steps of:
(b1) rearranging scatter symbols in the arrangement areas;
(b2) giving a payout according to the number of each kind of the scatter symbols rearranged;
(b3) when the input device receives a predetermined bet operation from outside and a predetermined condition is satisfied as a result of a rearrangement of scatter symbols, causing the count device to increment/decrement the count-value; and
(b4) giving a bonus payout when the count-value reaches a predetermined value.

3. A slot machine comprising:
a display having arrangement areas arrayed in a matrix in which plural kinds of scatter symbols are arranged;
a count device which increments/decrements a count-value; and
a controller which is programmed to operate in the following steps of:
(c1) rearranging scatter symbols in the arrangement areas;
(c2) giving a payout according to the number of each kind of the scatter symbols rearranged;
(c3) when a predetermined number of kinds of scatter symbols are rearranged without a payout as a result of a rearrangement of scatter symbols, causing the count device to increment/decrement the count-value; and
(c4) giving a bonus payout when the count-value reaches a predetermined value.

4. A slot machine comprising:
a display having arrangement areas arrayed in a matrix in which plural kinds of scatter symbols are arranged;
a count device which increments/decrements a count-value;
an input device which receives a bet operation from outside; and
a controller which is programmed to operate in the following steps of:
(d1) rearranging scatter symbols in the arrangement areas;
(d2) giving a payout according to the number of each kind of the scatter symbols rearranged;
(d3) when the input device receives a predetermined bet operation from outside and a predetermined number of kinds of scatter symbols are rearranged without a payout as a result of a rearrangement of scatter symbols, causing the count device to increment/decrement the count-value; and
(d4) giving a bonus payout when the count-value reaches a predetermined value.

5. A slot machine comprising:
a display having arrangement areas arrayed in a matrix in which plural kinds of scatter symbols are arranged;
a count device which increments/decrements a count-value;
an input device which receives a bet operation from outside; and
a controller which is programmed to operate in the following steps of:
(e1) rearranging scatter symbols in the arrangement areas;
(e2) giving a payout according to the number of each kind of the scatter symbols rearranged;
(e3-i) when the input device receives a predetermined bet operation from outside and a predetermined number of kinds of scatter symbols are rearranged without a payout as a result of a rearrangement of scatter symbols, causing the count device to increment/decrement the count-value, while (e3-ii) when the input device receives a predetermined bet operation from outside and a predetermined payout is given as a result of a rearrangement of scatter symbols, resetting the count-value; and
(e4) giving a bonus payout when the count-value reaches a predetermined value.

6. A playing method of a slot machine wherein scatter symbols are arranged in arrangement areas of a display, the arrangement areas being arrayed in a matrix, the playing method of the slot machine comprising the steps of:
(f1) rearranging scatter symbols in the arrangement areas;
(f2) giving a payout according to the number of each kind of the scatter symbols rearranged;
(f3) when a predetermined condition is satisfied as a result of a rearrangement of scatter symbols, causing the count device to increment/decrement the count-value; and
(f4) giving a bonus payout when the count-value reaches a predetermined value.
